(19) United States
(12) Patent Application Publication
(10) Pub. No.: US 2006/0270465 A1
(43) Pub. Date: Nov. 30, 2006

(54) Wireless microphone for public safety use

(76) Inventors: Matthew Lee, Chapel Hill, NC (US); Ich-Kien Lao, Raleigh, NC (US); William Bradford Silvernail, Raleigh, NC (US); Ray C. Henry, Wake Forest, NC (US); Randy Martinez, Burlington, NC (US)

Correspondence Address: John L. Sotomayor, Suite 300, 511 Davis Drive, Morrisville, NC, 27560, US

(21) Appl. No.: 11/262,724

(22) Filed: Nov. 1, 2005

Related U.S. Application Data
(60) Provisional application No. 60/685,974, filed on May 31, 2005.

(51) Int. Cl. H04M 1/00

(52) U.S. Cl. 455/569.1

(57) ABSTRACT

A wireless microphone system for use with a mobile digital recording system is disclosed. The wireless microphone system is comprised of a wireless microphone with a built-in transceiver and an in-vehicle transceiver that is connected to a mobile digital recording system. The wireless microphone can transmit audio information in real-time to the in-vehicle transceiver when the wireless microphone is in radio range of the in-vehicle transceiver. The wireless microphone can operate out of radio range of the in-vehicle transceiver by saving recorded audio data to a memory. The saved audio information can be downloaded to the in-vehicle transceiver when the wireless microphone is back in radio range of the in-vehicle transceiver, and the system is enabled to synchronize the saved audio information with other information collected by the mobile digital recording system during the time that the wireless microphone was out of range of the in-vehicle transceiver.

### PRIORITY

This application claims the benefit of priority to U.S. Provisional Application 60/685,974, filed May 31, 2005.

### BACKGROUND OF THE INVENTION

A variety of vehicle-installed surveillance systems have been developed that provide the ability to capture, record, and store video and audio information. Audio information is typically captured using a combination of hard-wired microphones mounted within the vehicle's interior cabin and wireless microphones that are carried by public safety personnel that transmit to a wireless receiver mounted within the vehicle. Common problems with prior art wireless microphones include the fact that such devices are typically passive. Such passive microphones must be manually activated to transmit, operate by transmitting in the blind on a given simplex frequency, transmit analog audio signals only, and must be manually tuned to transmit to a given receiver. The operator of such a prior art wireless microphone receives no indication when the wireless link in inoperative, and therefore cannot be assured that the audio information is captured by the vehicle-installed surveillance system.

Mobile and vehicle-installed recording systems are used by public safety agencies such as law enforcement agencies, among others, to capture video and audio information related to law enforcement activities. Such activities include routine traffic stops, arrests, surveillance, and the like (each, an “event”). Recording such events allows law enforcement agencies to corroborate the recollections, and testimony where applicable, of law enforcement officers. By using a wireless microphone to capture audio information during an event, it becomes possible to compile a more cohesive set of facts related to an event.

It is recognized in the art that one primary problem with prior art systems is that they do not buffer and store recorded information to ensure that a complete event is recorded. That is, when the microphone transmitter and receiver are physically separated by a distance that exceeds the wireless link radio range, transmitted information is lost. In addition, most prior art systems cannot distinguish between authorized users and unauthorized user, and therefore cannot be relied upon to ensure that the audio stream transmitted to the vehicle-installed receiver was received from the correct microphone/user pair. Such prior art systems transmit a single channel of analog audio signals using a single radio channel. In addition, such prior art microphone systems (microphone, transmitter, and receiver) require a physical connection to configure a pair the devices during initialization. The ability to transmit and receive multiple audio channels in digital form, as well as other information such as telemetry and the like, and to do so in full duplex mode, readily distinguishes the present invention from the prior art. The ability to authenticate microphone/user pairs, pair and configure the microphone/receiver pair over a wireless connection, buffer audio content, send audio and data information, time-stamp the audio and data content, and re-synchronize the buffered information to other information recorded by the vehicle-installed receiver is therefore advantageous.

### SUMMARY OF THE INVENTION

The present invention comprises apparatus and techniques associated with the authentication, capture, attribution, transfer, storage, retention, management and deletion of digital audio and telemetry information that has been collected or recorded by a wireless microphone system. The wireless microphone system, when used in conjunction with a mobile digital recording system, is primarily associated with collecting and recording audio information for use in accident investigation, law enforcement, public safety, transit operations, and the like. Utilizing the techniques exemplified by the present invention it is possible to stream digital audio in real-time when the wireless microphone operator is located within radio range of the mobile digital recording system, to capture and buffer audio information when the wireless microphone operator is operating beyond radio range, and to stream and ensure the synchronization of such information when the operator returns to radio range.

The present invention discloses methods and techniques for pairing a wireless microphone with vehicle-installed surveillance system or a mobile digital recording system such that the pairing is exclusive between desired devices without the need to have the devices physically connected at the time of pairing. This allows the mobile digital recording system or the vehicle-installed surveillance system to authenticate the source of the received audio signal to ensure that audio signals are not received from unauthorized wireless microphones, thereby ensuring the authentication of the received audio stream. This method also eliminates the need to use a docking station, cradle, or other physical connection in order to pair the microphone with the vehicle-installed surveillance system.

The present invention discloses methods to use a variety of audio compression algorithms, including but not limited to MPEG2 Level II or MPEG4 AAC, and to re-configure the compression algorithm on the fly to ensure that the audio stream is acceptable to the transceiver co-located with the mobile digital recording system and any video compression algorithm in use by the mobile digital recording system.

The present invention discloses methods to conserve battery power while remaining in an “always-on” state to ensure that ambient audio is always captured by changing the transmitter power level as appropriate based on the ambient conditions. Alternately, the wireless microphone may be switched into transmit mode manually by the microphone operator, or may be switched into transmit mode by the mobile digital recording system.

The present invention discloses methods for streaming audio information in real-time when the wireless microphone is within radio range of the mobile digital recording system, and for buffering and storing audio information when out of range. Upon returning to radio range, the wireless microphone is suitably enabled to simultaneously transmit real-time audio information while also transmitting buffered information. All audio information is time-stamped as it is recorded in real-time and buffered. The time stamp information is then used to digitally re-synchronize the buffered audio information with the video information captured by the mobile digital recording system. The wireless microphone is also suitably enabled to store buffered information long-term in the event that the wireless microphone does not return to radio range within a defined period of time. In this case, the buffered information may be downloaded and re-combined with a downloaded video recording that was captured by a mobile digital recording system and stored by an information management system on a fixed server. Buffered information, whether audio or telemetry, can also be tagged with user information from the mobile digital recording system for use in authentication and identification of such information for evidentiary and other purposes.

The present invention discloses methods for creating audio watermarks using randomly generated codes that are recorded outside the frequency range of the normally recorded audio spectrum. This allows the codes to be recorded without affecting the quality of the recorded audio source. Such codes are used to authenticate the audio source upon playback and/or synchronization with other information, such as video information, recorded by a mobile digital recording system.

The present invention further discloses proprietary methods for pairing one or more wireless microphones with a mobile digital recording system to prevent eavesdropping of the recorded audio signal and to ensure the authentication of the audio signal upon synchronization with the recorded video and/or other information.

The present invention discloses methods whereby the centralized time-reference of an intelligent information management system may utilize one or more external time-reference sources such as the Time Service Department of the United States Naval Observatory, the National Institute of Standards and Technology, a GPS signal, and the like.

The present invention discloses methods whereby the wireless microphone system provides multiple digital audio channels to support multiple users.

The present invention discloses methods whereby two-way digital telemetry information may be transmitted in parallel with the digital audio information. This allows the wireless microphone system to send and received information such as button presses, battery status, biometric data, images, user identification data, embedded software updates, multiple adjacent device pairing, and other information.

The features and novelty of the present invention are independent of the actual design and specifications of the ratio frequency transceiver subsystem. A few common characteristics of radio frequency transceivers are required such as support for digital information, packetization of information, asynchronous and synchronous (time-sensitive) information, two-way operation and multi-user capability. These common characteristics can be found in a variety of radio frequency transceiver subsystems such as Bluetooth, WiFi, ZigBee, DECT and UWB. Therefore, the features and novelty of the present invention can be applied to any of these radio frequency transceiver subsystems.

### BRIEF DESCRIPTION OF THE DRAWINGS

FIG. 1 illustrates the use of bit error rate (BER) to determine when a wireless microphone is in range or out of range of an IVT.

FIG. 2 illustrates a single user scenario for pairing a BPT to an IVT in accordance with an exemplary embodiment of the present invention.

FIG. 3 illustrates a single user scenario for the situation where a BPT leaves the radio range of an IVT and then returns.

FIG. 4 illustrates a multiple user scenario for pairing a BPT to an IVT in accordance with an exemplary embodiment of the present invention.

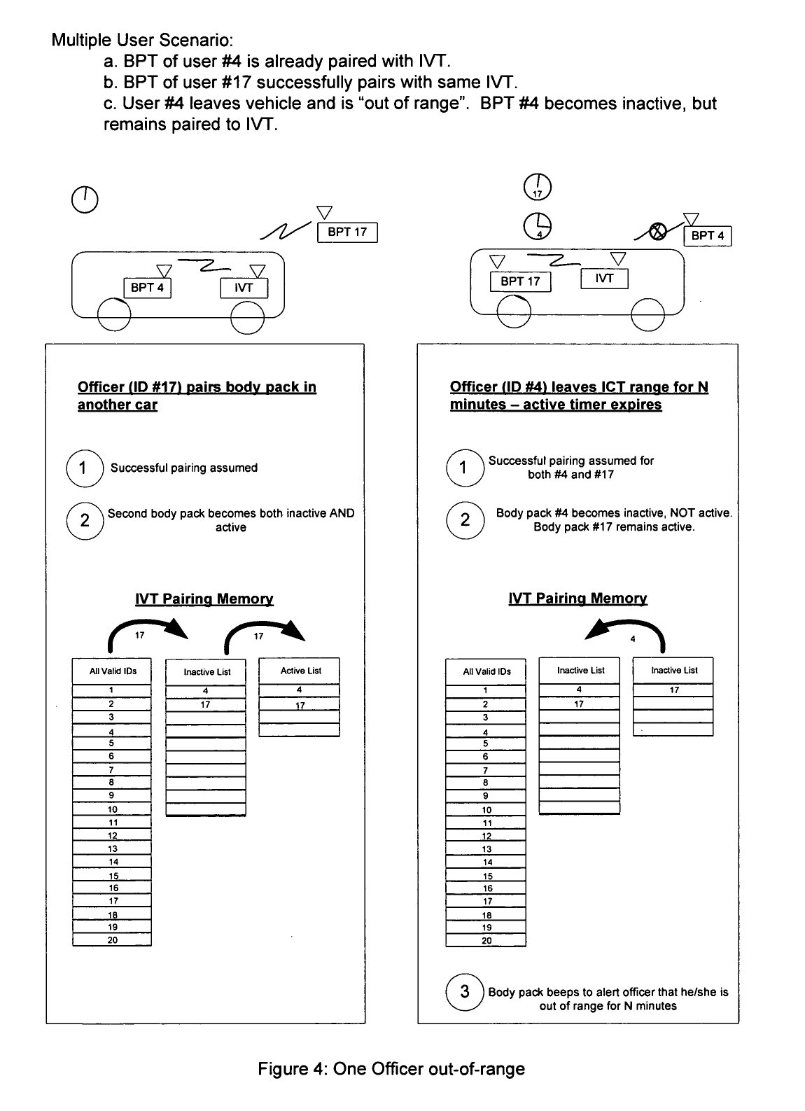

FIG. 5 illustrates a multiple user scenario for pairing a BPT to an IVT for the situation where an IVT is already paired with a maximal number of BPTs.

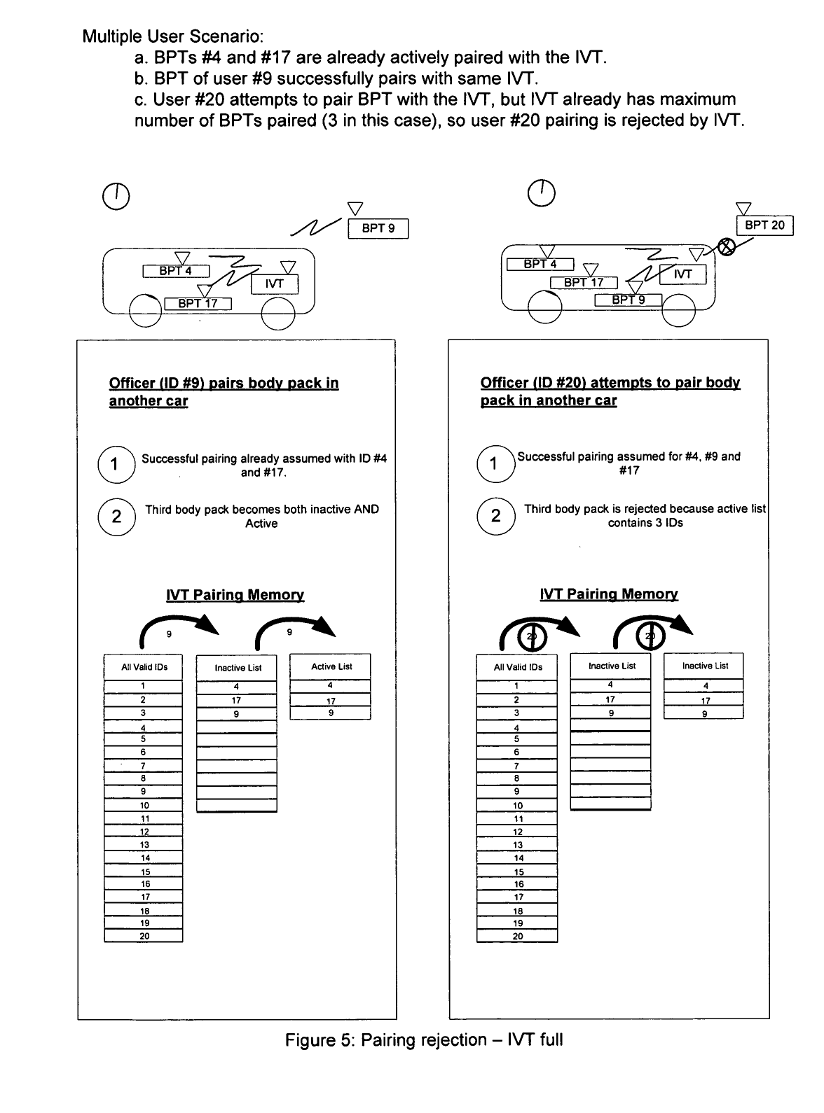

FIG. 6 illustrates a block diagram wherein multiple BPTs are paired with a single IVT of a mobile digital recording system.

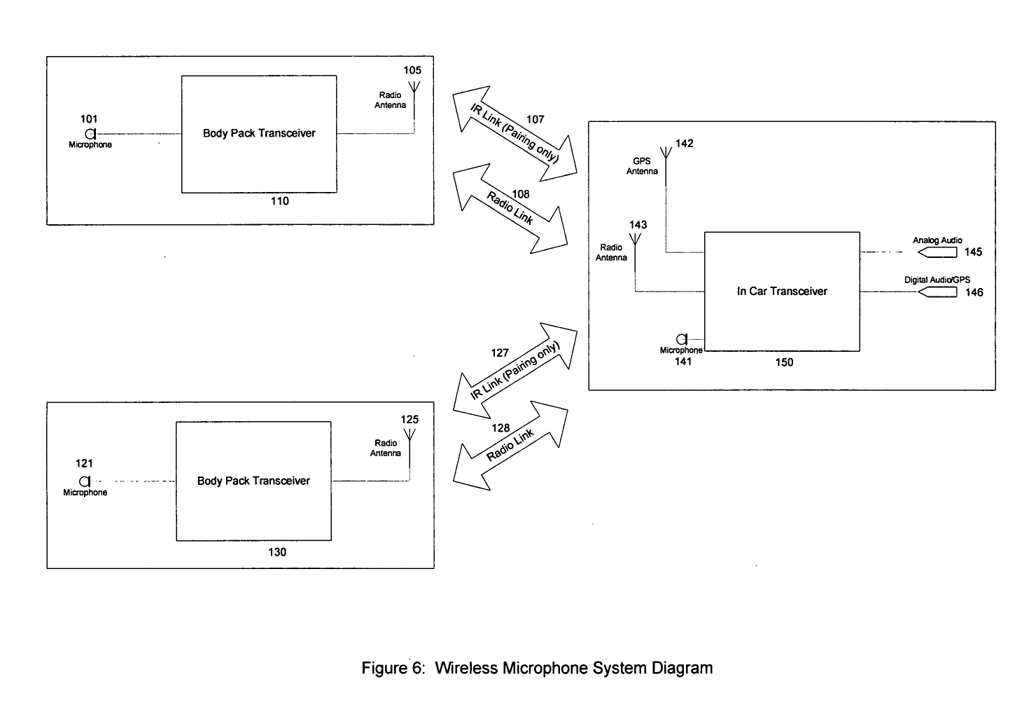

FIG. 7 illustrates a block diagram of a BPT in accordance with an exemplary embodiment of the present invention.

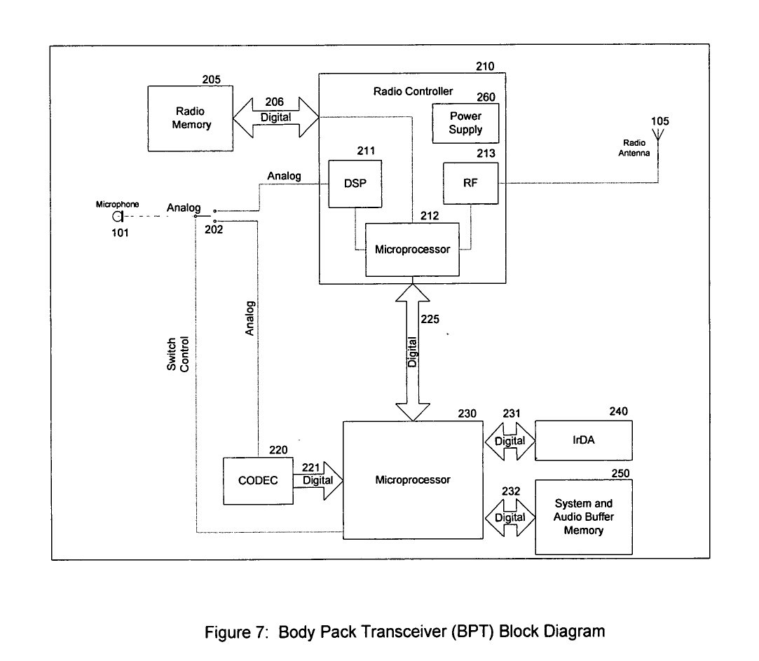

FIG. 8 illustrates a block diagram of an IVT in accordance with an exemplary embodiment of the present invention.

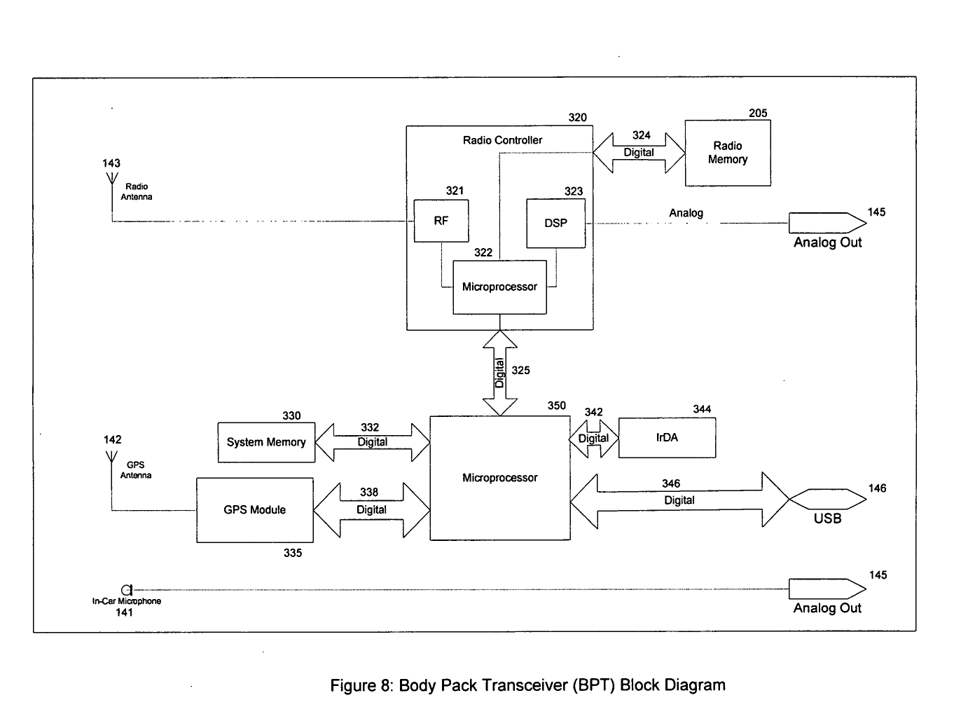

FIG. 9 illustrates the process flow for the Audio System Record functionality between the BPT and the IVT.

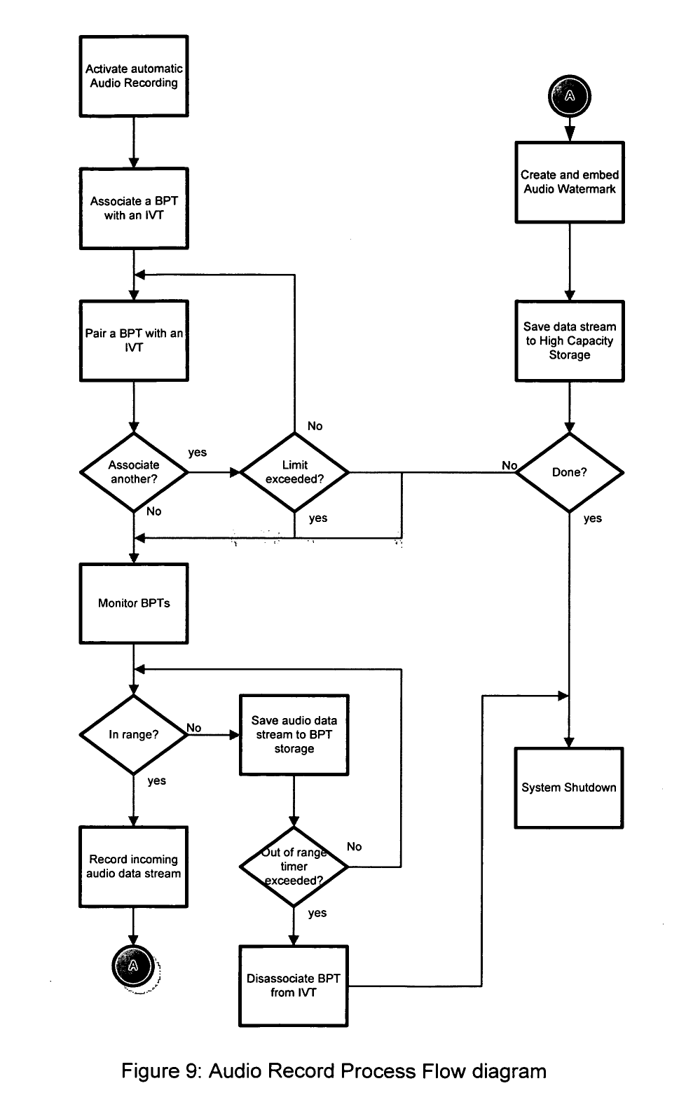

FIG. 10 illustrates the top, rear, side and front views of an IVT of the present invention showing an antenna, status LEDs, an infrared transmitter window, an external connector and a record indicator.

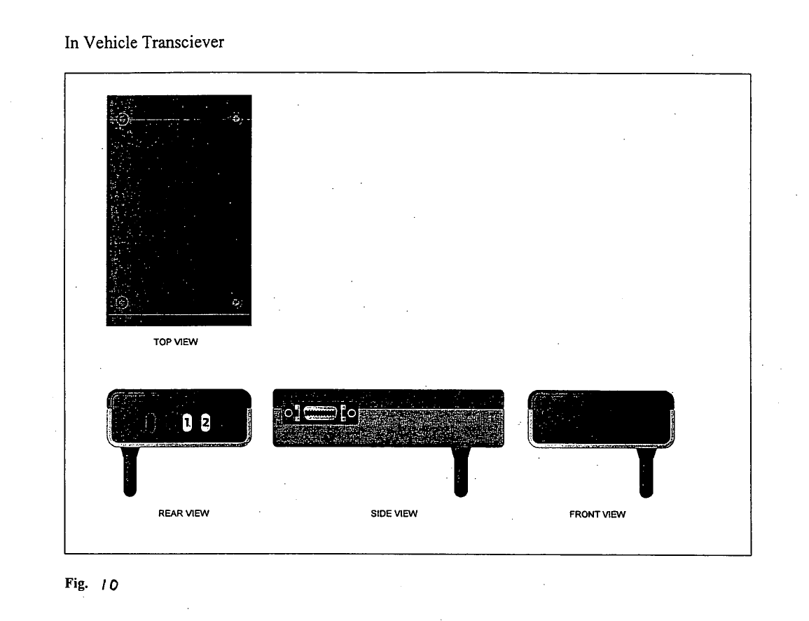

FIG. 11 illustrates a left side view of a BPT of the present invention showing a record button and a remote activation button.

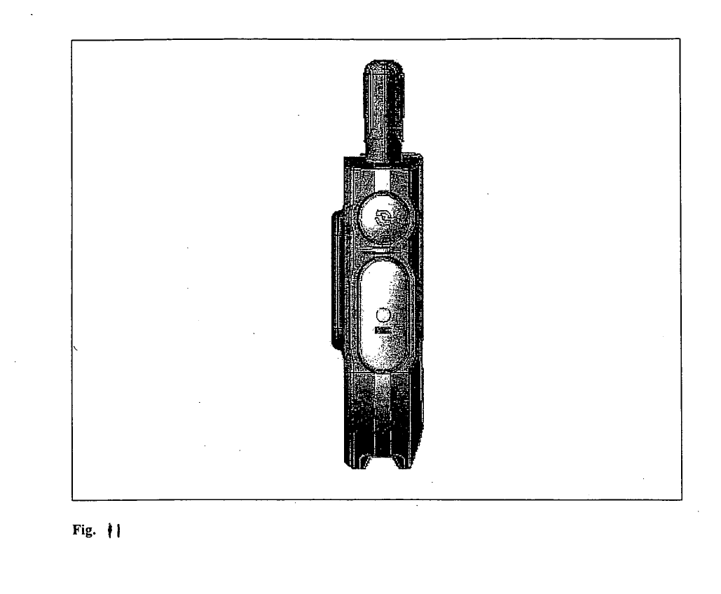

FIG. 12 illustrates a perspective quarter view of the BPT of the present invention.

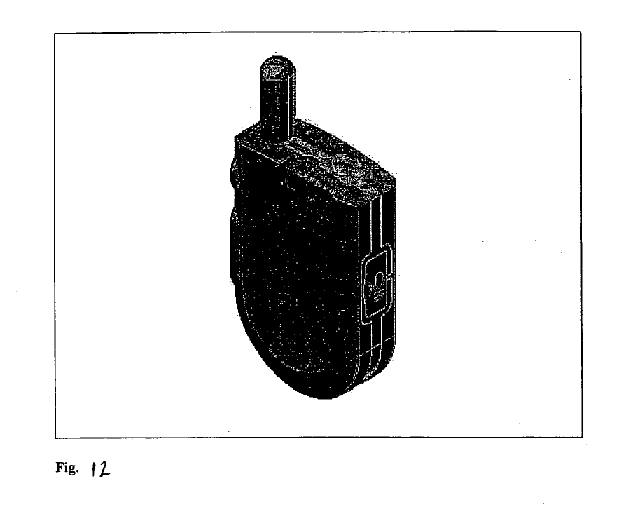

### DETAILED DESCRIPTION

The wireless microphone sub-system is used as a part of a mobile video/audio recording system that can be applied within the public safety and transit markets. As a part of the mobile video/audio recording system, a wireless microphone is used to collect audio input directly from a user when they are not in the vehicle that houses the video recording and wired audio recording sub-systems. In this manner, the user may have freedom of movement inside and outside of the vehicle without losing the ability to record the audio within a certain radius of the vehicle.

The video/audio recording system is comprised of the following basic components: (1) a mobile in-vehicle digital audio/video/data recorder; (2) a wireless digital audio recorder and transceiver body pack (Body Pack Transceiver or BPT); (3) an in-vehicle transceiver to send and receive signals to/from wireless microphone (In-Vehicle Transceiver or IVT); and (4) a central server management system to view and manage videos after recording.

The wireless microphone sub-system is comprised of 2 main pieces: (1) a BPT 110; and (2) an IVT 150. The BPT 110 comprises a power supply 260, a microphone 101, a memory 250, a microprocessor 230, status indicators, user-programmable buttons, an infrared transceiver 260, a radio transceiver 210, an antenna that transmits the wireless signals 105, and software. The BPT 110 may also comprise an optional external lavaliere microphone. The IVT 150 comprises a radio receiver 321, an infrared transceiver 344, a microprocessor 350, status indicators, an antenna to receive and transmit signals 143, interface connectors to connect to a video/audio digital recording system 325, and software.

Configurable Compression Algorithm: The mobile digital recording system 210 can support multiple compression algorithms that can be configured on the fly. The mobile digital recording system 210 can support either MPEG2 or MPEG4 compression, as well as other industry standard compression algorithms. For this reason, the wireless microphone also needs to support multiple audio compression algorithms, including but not limited to MPEG2 Level II or MPEG4 AAC. Instead of fixing the wireless microphone to work with a specific audio algorithm, the configuration of the wireless microphone can be done on the fly at the point of encoding when the microphone is paired with the transceiver and in-vehicle mobile digital recording system 320.

When the BPT 110 is paired with its appropriate IVT 150, the IVT 150 will send an appropriate signal to the BPT 110. This signal will include information to the BPT 110 which indicates which compression mode is supported by the IVT 150 and in-car system with which the BPT 110 is paired. At that point, the BPT 110 will be configured to the appropriate compression algorithm and will encode and send the audio stream in the correct format. In this manner, the BPT 110 can support multiple compression algorithms and have the encoding configured on the fly. The benefits of using a matching digital audio compression algorithm such as MPEG2 Level II in the BPT 110 include (1) avoiding signal degradation by using a single type of compression (Mic(Analog)→digitally compressed format→Digital Storage or Mic(Analog)→digitally compressed format→Analog); (2) avoid signal degradation by transcoding audio from one digital format to another, (3) greater control over sound quality; (4) easier access to compressed audio to dump to a buffer; (5) tighter compression ([i] reduce bandwidth needed across the wireless link, [ii] permit back channel uploading of buffered data, [iii]less memory needed for buffering); (6) the ability to pass all audio digitally via a shared wired digital link from the IVT 150 to the mobile digital recording system ([i] reduce or eliminate cabling, [ii] reduce signal loss); (7) offload compression and application from the mobile digital recording system central processor to the microprocessor/microcontroller within the BPT 110 (increases portability to other protocols such as 4.0 GHz band, Zigbee, etc); and (8) reduce latency from the capture of the audio information to the mobile digital video recording device to improved audio and video synchronization (to avoid lip synchronization in the combined audio/video stream).

Auto Activation: The wireless microphone is technically “on” at all times. However, power is conserved within the microphone by lowering the transmitter power when the microphone is not “activated”. When the microphone is “activated”, the transmitter power in the body pack of the wireless microphone is automatically raised to the appropriate level required for normal operation. When the microphone is not activated, the transmitter power is lowered so that battery capacity is conserved and the microphone will not transmit an audio signal to the mobile digital recording system but will instead buffer the audio data. The wireless microphone can be activated in one of two ways: (1) the BPT 110 user can manually activate the microphone of the BPT 110 by pressing a button to “activate” the microphone, or (2) the BPT 110 can be activated by a signal from the mobile digital recording system whenever the mobile digital recording system is in “record” mode.

Buffer Record for Out of Range Mode: During wireless microphone operation in conjunction with a mobile digital recording system 320, there are many scenarios where the microphone user may move out of radio range of the transceiver 321. In such a case, the transceiver will not be able to actively pick up the signal from the wireless microphone and record live audio. In prior art systems, audio would be lost. In the present invention, the wireless microphone treats the out of range operation differently to avoid losing any audio data.

During operation, if the BPT 110 goes into “out of range” mode, the audio stream will automatically be saved into a memory buffer 250 within the BPT 110. Then, when the BPT 110 is no longer in “out of range” mode, the audio stream will be delivered to the mobile digital recording system 210 using the data channel of the wireless radio link and seamlessly recorded with the appropriate video sequence. The BPT 110 is suitably enabled to transmit the buffered “out of range” audio stream while simultaneously streaming live audio in real-time. The live audio stream is applied to the video stream being recorded by the mobile digital recording system as normally done in real time. The buffered audio captured locally by the body pack when out of range, sent simultaneously with the live audio, is re-applied to the “past” video stream using processing within the mobile digital recording system itself. Time stamps embedded in both the audio and the video streams are used to correctly synchronize and align the two data streams. Toggle triggers for “out of range” mode and seamless assimilation of buffered audio with video are described in additional provisions below.

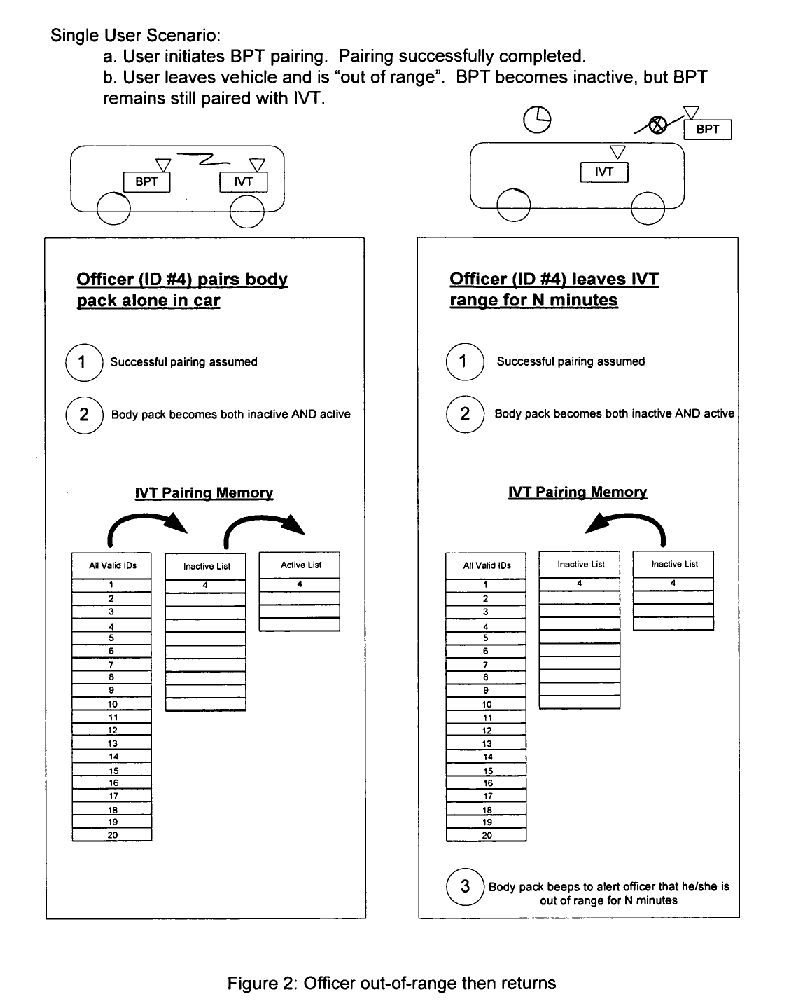

Initiation of Audio Recording When Out of Range: As shown in FIG. 2, The wireless microphone may also be used to initiate a recording when communication with the in-vehicle mobile digital recording system transceiver is not available due to an out of range condition or otherwise. The wireless microphone will buffer the audio data until communications with the in-vehicle transceiver is available. Once a communications link between the wireless microphone and the mobile digital recording system transceiver is re-initiated, a recording session will start with the in-vehicle transceiver, and the buffered audio will be uploaded as described above. However, if the wireless microphone never returns within radio range of the in-vehicle transceiver, the audio recording may still be preserved within the wireless microphone. Such an audio recording event is known as an orphan audio session. This orphaned audio session will be uploaded to a mobile digital recording system when an in-vehicle transceiver becomes available, even if the mobile digital recording system is a different system from the one with which the wireless microphone was initially paired. The orphaned recording can be identified by the date and time on which it was recorded, but also by other user identification information that was entered into the original mobile digital recording system and transferred to the BPT 110 during the original pairing. This orphan recording may exist independent of any other recording sessions (either within the memory buffer of the BPT 110 or another memory within a mobile digital recording system or an information management system).

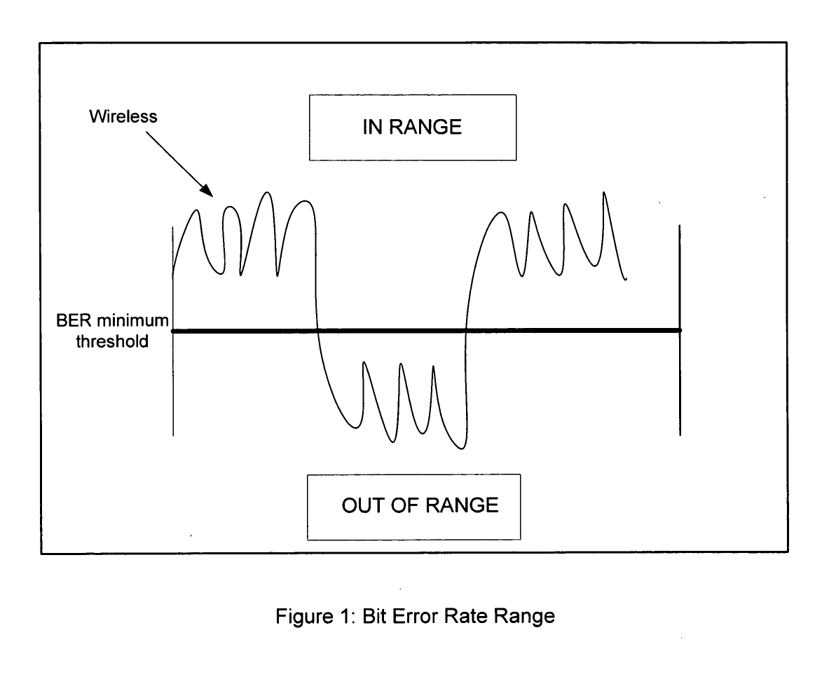

Toggle Trigger for Out of Range Mode: During operation of the wireless microphone, there is a trigger that will manage the recording of audio to the memory buffer and the transfer of that data to the mobile digital recording system. This trigger indicates whether or not the wireless microphone is “out of range”. The wireless microphone manages the toggling of this trigger by continually analyzing one or more signal quality parameters, such as the bit error rate (BER) of the wireless signal, as shown in FIG. 1. Based on the configuration of the system, a minimum threshold will be set for the BER. When this threshold is reached, the system will be toggled to either “in range” or “out of range” mode. In addition to the analysis of the BER, the system will also monitor near-end and far-end receive signal strength indicators (RSSI) and packet resend requests, and will use these parameters in conjunction with BER to determine link quality and trigger threshold(s).

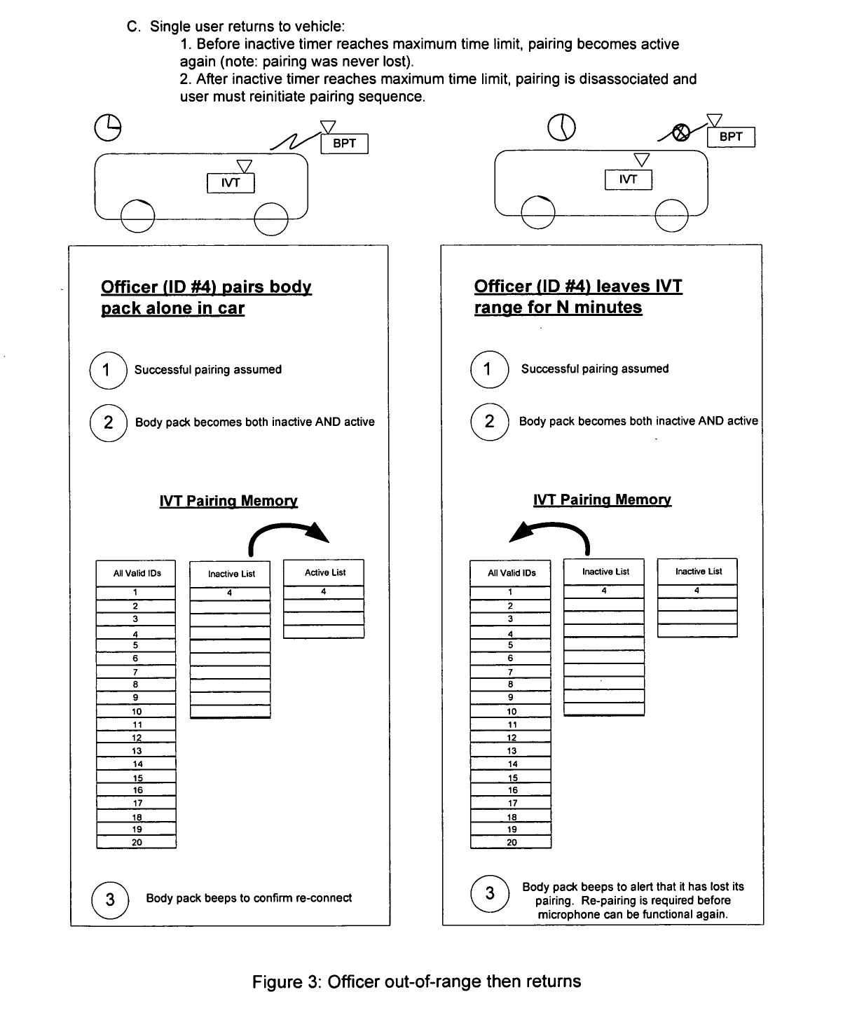

As shown in FIG. 3, when the BPT 110 is “out of range”, a beep or vibration will indicate to the microphone user that he/she is now “out of range” (if the BPT 110 were previously paired when it was “in range”). Once a BPT 110 goes “out of range”, a configurable timer is started. As long as that timer does not expire, the BPT 110 will retain its pairing when it reaches “in range” again and will send the appropriate audio to the in-car system when it is back “in range”. If the timer expires, the BPT 110 will no longer be paired to the mobile digital recording system and the recorded audio will be treated as an orphan recording. Re-pairing is now required before the microphone can be functional once again.

Microphone Battery Power Conservation: One mode of operation allows the wireless microphone system to continuously transmit digital audio information in short bursts, and another mode of operation allows for significantly reduced power consumption by transmitting in less frequent long bursts. One alternative to sending audio information to the mobile digital recording system transceiver 150 in short burst transmit mode using a wireless link, which tends to drain battery power relatively quickly, is to save several seconds worth of audio data in the memory of the BPT 110 for later transmission. Once enough data is saved, the audio data will be sent in relatively long bursts at high speed (approximately 723 Kbs) to the IVT 150. This feature further facilitates multiple user access to the IVT 150. To preserve the real time nature of recorded events, a microprocessor real-time clock in the BPT 110 will be synchronized to the in-vehicle clock of a mobile digital recording system.

Audio Watermark: When audio is recorded by a mobile digital recording system, markers are created within the recorded audio stream. These markers are created based on a unique key for the mobile digital recording system. This unique key is used to create randomly generated codes that set the markers in the audio stream. Upon decoding the randomly generated codes and playing of the audio stream, the unique key is used to validate that the audio recorded is matched to the appropriate place within the video/audio stream, and it also validates that the audio matches the key. In this manner, the audio stream is authenticated as being recorded without alteration or manipulation, thereby creating a verifiable evidentiary chain. The user of the unique key that generates the random code markers creates a secure audio stream that can be matched to a “home” mobile digital recording system. This authentication scheme is similar to what is used to create watermarking for video signals, but in this system a different methodology us used to ensure the security of the audio stream. The novelty here is that the embedded audio water-markings are outside of the frequency range of the normally-used audio spectrum. This allows the audio stream to be watermarked without affecting the quality of the audio stream and thereby allows maximum sound quality.

Infrared Pairing Activation: Each body pack transceiver (BPT 110) and in-vehicle transceiver (IVT 150) contains an infrared transceiver capable of sending and receiving pairing data using an optical infrared transceiver link 240. The BPT 110 and IVT 150 infrared transceivers have a limited range of about 1 meter, and about 30 degrees of visible width. This feature is used to address several of the limiting issues that exist when using a radio frequency (RF) wireless over-the-air pairing system. These issues include: (1) initiating the pairing activation by pressing a button on the BPT 110 to locate the nearest IVT 150 unit with which to be paired and initiate pairing activity; (2) the risk of a security breach due to eavesdropping that exists when sending pairing data over an RF link; and (3) interference from multiple simultaneous pairing operations that could be occurring in or near adjacent vehicles. A short range two-way infrared data link (107, 127) is used to address these issues. The pairing process is accomplished via the following steps: (1) the BPT 110 infrared transceiver window is aimed at an IVT 150 infrared transceiver window; (2) the pairing button is pressed on the BPT 110; (3) the BPT 110 sends its RF wireless address and pairing information 107 to the IVT 150; (4) the IVT 150 confirms receipt of the pairing information from the BPT 110, and replies to the BPT 110 with the IVT RF wireless address and pairing information; and (5) the BPT 110 and the IVT 150 will then only pair to addresses exchanged over that infrared link.

There is no need for a pairing button on the IVT 150 to also be pressed in a normal pairing process since the IVT 150 exchanges pairing information with the BPT 110 in response to the receipt of infrared pairing data 107 from the BPT 110. This system removes the need for the user to simultaneously push pairing buttons on the IVT 150 and the BPT 110. The pairing process of the present invention now occurs over infrared rather than via an RF radio link. RF-based wireless pairing systems are also susceptible to eavesdropping and intrusion if a third party can intercept the pairing information from the RF radio link during the pairing process. A short range, narrow width, infrared-based system of the present invention dramatically reduces the range at which such pairing data can be intercepted. A third party seeking to intercept such pairing data would also need to greatly increase the complexity of their system to include RF and optical reception and transmission techniques. The infrared exchange also eliminates having multiple BPT/IVT 110/150 pairs linking to other BPT 110 or IVT 150 units if several units are pairing at the same time. A short range of about one meter prevents address and system information from leaving the immediate vicinity of a vehicle and unintentionally pairing with another unit.

Pairing: This provision contains a number of sub-provisions that are detailed below. The general premise behind this provision embodies all the intelligence behind automatically pairing a BPT 110 with an IVT 150 intelligently and wirelessly—no docking or manual configuration is required. The intelligent pairing solution provides for multiple simultaneous adjacent pairing activities at times when many users are co-located within a small geographic area, such as a single parking lot, and initiate pairing activities for a number of BPTs within a short span of time.

Each BPT 110 and IVT 150 will have an approved user list. This approved user list will be downloaded to the IVT 150 when the IVT 150 is linked to the mobile digital recording system. Each BPT/IVT 110/150 pair would have to match the approved user list or the pairing will be blocked. Each IVT 150 can have multiple BPTs (110,130) associated therewith, assuming wireless bandwidth is available. One BPT 110 may be designated as “primary”. If multiple BPTs 110 are associated with an IVT, and an event requires bandwidth allocation for other purposes, the mobile digital recording system is suitably enabled to drop non-primary BPTs 110 off-line (out of range mode).

We claim:

1. An apparatus for recording and storing digital audio and telemetry information comprising:
at least one body pack transceiver (BPT) separably associated with a mobile digital recording system installed within a vehicle;
an In-Vehicle transceiver (IVT) to send and receive transmissions to and from said BPT;
at least two infrared communications transceivers;
at least two radio frequency (RF) communications transceivers,
and at least two radio communications antennas.

2. The apparatus of claim 1 wherein the BPT further comprises:
a power supply;
a wireless microphone;
a plurality of activation buttons mounted within the external case of the BPT;
at least one transceiver to transmit and receive radio communications signals and data;
at least one transceiver to transmit and receive infrared communications signals and data;
a digital memory storage buffer;
at least one microprocessor;
at least one radio frequency antenna;
a plurality of programmed modules wherein said modules are operational to produce programmed behaviors within the BPT.

3. The apparatus of claim 1 wherein the IVT further comprises:
a radio receiver to receive radio communication signals and data;
an infrared transceiver to transmit and receive infrared communications signals and data;
at least one microprocessor;
at least two status indicators;
a radio frequency antenna;
a plurality of interface connectors to connect the IVT to an in-vehicle mobile digital video/audio recording system;
a plurality of programmed modules wherein said modules are operational to produce programmed behaviors within the IVT.

4. The apparatus according to claim 2, further comprising:
an activation button configured to initiate a pairing activity;
an activation button configured to initiate audio recording activity;
an activation button configured to initiate status activity and activate status indicator LEDs based upon the result;

5. The apparatus according to claim 2, further comprising:
a program module operational to create markers within a recorded audio stream as recorded by said microphone, where the markers comprise an Audio Watermark;
said program module creating said markers through the use of a unique key value used to generate said markers and subsequently embed them within the recorded audio stream;
said markers being operational to authenticate the recorded audio stream to a receiving system, such as an IVT, and providing location information within the recorded audio stream;
wherein the embedded markers are outside of the frequency range of the normally-used audio spectrum, allowing the audio stream to be watermarked without affecting the quality of the recorded audio stream.

6. The apparatus according to claim 2, further comprising:
said infrared transceiver comprises a short range, typically less than 1 meter, two-way communication connection;
said infrared transceiver and said radio transceiver operational in tandem through the selection of a button to initiate pairing of a particular BPT with an IVT;
said pairing being accomplished, after the selection of the button, by:
i. aiming a BPT infrared transceiver window at an infrared transceiver window within an IVT with which it is to be paired;
ii. the BPT transmitting, over the infrared communication connection, its radio frequency (RF) wireless address and pairing information to the IVT;
iii. the IVT transmitting a confirmation of the pairing information from said BPT;
iv. and the IVT transmitting a reply to the BPT using the newly received RF communication information.
wherein said pairing information is exchanged to establish a short range, narrow width, infrared-based communication channel which dramatically reduces the danger of intercepted communication signals between the paired BPT and IVT equipment.

7. The apparatus according to claim 6, further comprising:
wherein an IVT may be paired with multiple BPTs.

8. The apparatus according to claim 6, further comprising:
A program module within a paired BPT operational to detect when said BPT moves beyond the range of the short range, narrow width, infrared-based communication channel established with a paired IVT;
a program module operational to redirect the audio data captured by the BPT microphone into an integral digital memory storage element;
a program module operational to detect when the BPT is once again within communication range with a paired IVT;
Wherein the BPT will re-establish communication with its paired IVT and transfer all audio data stored in the digital memory storage element to the paired IVT.

9. The apparatus according to claim 8, further comprising:
once communication has been re-established between a BPT and its paired IVT, transmission of the buffered audio data from said BPT, recorded when “out of range”, while simultaneously streaming live audio data in real-time.

10. The apparatus according to claim 1, further comprising:
wherein said radio frequency transceivers are configured to support subsystem standards such as Bluetooth, WiFi, ZigBee, DECT and UWB.

11. A process for recording, authenticating, synchronizing, and storing digital audio and telemetry information using a wireless microphone associated with a mobile digital recording system installed within a vehicle comprising:
a) initiating activation of audio recording automatically;
b) associating at least one Body Pack Transceiver (BPT) with a mobile digital recording system through an In-Vehicle Transceiver (IVT) installed within a vehicle;
c) associating said IVT to send and receive communication signals to and from at least one BPT;
d) performing a pairing activity between said IVT and at least one BPT;
e) monitoring all associated BPTs for signal in-range and out-of-range status;
f) recording an incoming audio data stream;
g) creating and recording an Audio Watermark and embedding said Audio Watermark with said recorded audio data stream;
h) storing said audio data stream and Audio Watermark within a high capacity storage device;
wherein said audio data stream and Audio Watermark may be retrieved, in-whole or in-part from the high capacity storage device for later synchronization with recorded video and meta data for use in evidentiary proceedings.

12. The process of claim 11 for recording, authenticating, synchronizing, and storing digital audio and telemetry information using a wireless microphone associated with a mobile digital recording system installed within a vehicle, the step of performing a pairing activity further comprising:
a) activating a wireless microphone within the BPT from a “standby mode” by pressing an activation button on the case of the BPT or by sending an activation signal to the BPT from the mobile digital recording system whenever the mobile digital recording system is in “record” mode;
b) pairing an activated wireless microphone within a BPT with an IVT by selecting a pairing activation button on the case of the BPT;
c) accomplishing said pairing activity, after the selection of the pairing activation button by performing the following steps:
i. aiming a BPT infrared transceiver window at an infrared transceiver window within an IVT with which it is to be paired;
ii. the BPT transmitting, over the infrared communication connection, its radio frequency (RF) wireless address and pairing information to the IVT;
iii. the IVT transmitting a confirmation of the pairing information from said BPT;
iv. and the IVT transmitting a reply to the BPT using the newly received RF communication information.
Wherein the pairing information is exchanged to establish a short range, narrow width, infrared-based communication channel which dramatically reduces the danger of intercepted communications signals and provides secure authentication of said signals between a BPT and an IVT.

13. The process of claim 11 for recording, authenticating, synchronizing, and storing digital audio and telemetry information using a wireless microphone associated with a mobile digital recording system installed within a vehicle, the step of monitoring range status further comprising:
a) monitor the signal status within the BPT for a disconnection status, such as, for example, abnormal disconnect;
b) upon receipt of said disconnect signal, the BPT resets its operational mode to “out-of-range” status, and continue to monitor signal status;
c) upon entering “out-of-range” status, store the audio stream data to a memory buffer within the BPT;
d) upon detection of a reconnect signal, the BPT resets its operational mode to “in-range” status and transmits all buffered audio stream data to the IVT while continuing to stream live audio in real-time, simultaneously, to the IVT;
Wherein the BPT may change operational status to “in-range” and “out-of-range” status conditions with no loss of audio data recorded and forwarded to the IVT.

14. The process of claim 11 for recording, authenticating, synchronizing, and storing digital audio and telemetry information using a wireless microphone associated with a mobile digital recording system installed within a vehicle, the step of creating and embedding an Audio Watermark further comprising:
a) a program module operational to create markers within a recorded audio stream as recorded by said microphone, where the markers comprise an Audio Watermark;
b) said program module creating said markers through the use of a unique key value used to generate said markers and subsequently embed them within the recorded audio stream;
c) said markers being operational to authenticate the recorded audio stream to a receiving system, such as an IVT, and providing location information within the recorded audio stream;
wherein the embedded markers are outside of the frequency range of the normally-used audio spectrum, allowing the audio stream to be watermarked without affecting the quality of the recorded audio stream.

15. A computer program embodied within a computer readable medium for recording, authenticating, synchronizing, and storing digital audio and telemetry information using a wireless microphone associated with a mobile digital recording system installed within a vehicle comprising:
a) initiating activation of audio recording automatically;
b) associating at least one Body Pack Transceiver (BPT) with a mobile digital recording system through an In-Vehicle Transceiver (IVT) installed within a vehicle;
c) associating said IVT to send and receive communication signals to and from at least one BPT;
d) performing a pairing activity between said IVT and at least one BPT;
e) monitoring all associated BPTs for signal in-range and out-of-range status;
f) recording an incoming audio data stream;
g) creating and recording an Audio Watermark and embedding said Audio Watermark with said recorded audio data stream;
h) storing said audio data stream and Audio Watermark within a high capacity storage device;
wherein said audio data stream and Audio Watermark may be retrieved, in-whole or in-part from the high capacity storage device for later synchronization with recorded video and meta data for use in evidentiary proceedings.

16. The computer program embodied within a computer readable medium of claim 15 for recording, authenticating, synchronizing, and storing digital audio and telemetry information using a wireless microphone associated with a mobile digital recording system installed within a vehicle, the step of performing a pairing activity further comprising:
a) activating a wireless microphone within the BPT from a “standby mode” by pressing an activation button on the case of the BPT or by sending an activation signal to the BPT from the mobile digital recording system whenever the mobile digital recording system is in “record” mode;
b) pairing an activated wireless microphone within a BPT with an IVT by selecting a pairing activation button on the case of the BPT;
c) accomplishing said pairing activity, after the selection of the pairing activation button by performing the following steps:
i. aiming a BPT infrared transceiver window at an infrared transceiver window within an IVT with which it is to be paired;
v. the BPT transmitting, over the infrared communication connection, its radio frequency (RF) wireless address and pairing information to the IVT;
vi. the IVT transmitting a confirmation of the pairing information from said BPT;
vii. and the IVT transmitting a reply to the BPT using the newly received RF communication information.
Wherein the pairing information is exchanged to establish a short range, narrow width, infrared-based communication channel which dramatically reduces the danger of intercepted communications signals and provides secure authentication of said signals between a BPT and an IVT.

17. The computer program embodied within a computer readable medium of claim 15 for recording, authenticating, synchronizing, and storing digital audio and telemetry information using a wireless microphone associated with a mobile digital recording system installed within a vehicle, the step of monitoring range status further comprising:
a) monitor the signal status within the BPT for a disconnection status, such as, for example, abnormal disconnect;
b) upon receipt of said disconnect signal, the BPT resets its operational mode to “out-of-range” status, and continue to monitor signal status;
c) upon entering “out-of-range” status, store the audio stream data to a memory buffer within the BPT;
d) upon detection of a reconnect signal, the BPT resets its operational mode to “in-range” status and transmits all buffered audio stream data to the IVT while continuing to stream live audio in real-time, simultaneously, to the IVT;
Wherein the BPT may change operational status to “in-range” and “out-of-range” status conditions with no loss of audio data recorded and forwarded to the IVT.

18. The computer program embodied within a computer readable medium of claim 15 for recording, authenticating, synchronizing, and storing digital audio and telemetry information using a wireless microphone associated with a mobile digital recording system installed within a vehicle, the step of creating and embedding an Audio Watermark further comprising:
a) a program module operational to create markers within a recorded audio stream as recorded by said microphone, where the markers comprise an Audio Watermark;
b) said program module creating said markers through the use of a unique key value used to generate said markers and subsequently embed them within the recorded audio stream;
c) said markers being operational to authenticate the recorded audio stream to a receiving system, such as an IVT, and providing location information within the recorded audio stream;
wherein the embedded markers are outside of the frequency range of the normally-used audio spectrum, allowing the audio stream to be watermarked without affecting the quality of the recorded audio stream.
